(19) United States
(12) Patent Application Publication
(10) Pub. No.: US 2010/0321172 A1
(43) Pub. Date: Dec. 23, 2010

(54) WINDOW GLASS BREAKAGE DETECTOR AND BREAKAGE DETECTING APPARATUS

(75) Inventors: Tsuneo Suzuki, Kariya-shi (JP); Mitsugu Kobayashi, Kariya-shi (JP)

Correspondence Address: GREENBLUM & BERNSTEIN, P.L.C., 1950 ROLAND CLARKE PLACE, RESTON, VA, 20191, US

(73) Assignee: KABUSHIKI KAISHA TOYOTA JIDOSHOKKI, Aichi-ken (JP)

(21) Appl. No.: 12/865,422

(22) PCT Filed: Feb. 20, 2009
(86) PCT No.: PCT/JP2009/052972

§ 371 Date: Jul. 30, 2010

(30) Foreign Application Priority Data
Feb. 25, 2008 (JP) 2008-043403

(51) Int. Cl. B60Q 1/00

(52) U.S. Cl. 340/425.5

(57) ABSTRACT

A window glass breakage detection tool attached to a window glass of a vehicle to detect breakage of the window glass is disclosed. When the window glass is unbroken, at least part of the breakage detection tool is located in a through hole arranged in the window glass and urges a wall of the through hole in a direction expanding the through hole with an elastic force of the detection tool. When the window glass breaks, the breakage detection tool shatters the window glass at a portion surrounding the through hole and the detector is at least partially displaced.

### FIELD OF THE INVENTION

The present invention relates to a window glass breakage detection tool and breakage detection device for a vehicle.

### BACKGROUND OF THE INVENTION

Patent Document 1 discloses a device that detects breakage of a window glass of a vehicle to prevent theft. As shown in FIG. 12, a window glass 100 is supported by a carrier plate 111 of a cable type window regulator 110. The device includes a compression coil spring 120 that urges the carrier plate 111 in a closing direction of the window glass 100 when the window glass 100 is located at a fully-closed position where it closes a window opening. Breakage of the window glass 100 releases the engagement of a stopper pin 105, which is arranged on the window glass 100, and a hook 106, which is arranged on the vehicle body. Then, the compression coil spring 120 further moves the window glass 100 in the closing direction from the fully-closed position. A limit switch 130 detects the movement of the carrier plate 111 and thereby detects breakage of the window glass.

Reinforced glass is normally used as the window glass 100. The application of an impact breaks the window glass into pieces. However, part of the window glass may hold together without being shattered. When the window glass 100 holds together near the carrier plate 111, the carrier plate 111 may not move in the closing direction in which case breakage of the window glass 100 would not be detected.

### [Patent Document 1] Japanese Laid-Open Patent Publication No. 11-321564

### SUMMARY OF THE INVENTION

It is an object of the present invention to provide a window glass breakage detection tool and a breakage detection device that ensure detection of window glass breakage even when the window glass holds together and is not completely shattered.

To achieve the above object, one aspect of the present invention provides a window glass breakage detection tool attached to a window glass for a vehicle and used to detect breakage of the window glass. When the window glass is unbroken, at least part of the breakage detection tool is located in a through hole arranged in the window glass and urges a wall of the through hole in a direction expanding the through hole with an elastic force of the detection tool. When the window glass breaks, the breakage detection tool shatters the window glass at a portion surrounding the through hole and the detector is at least partially displaced.

A further aspect of the present invention provides a breakage detection device that detects breakage of a window glass of a vehicle. The breakage detection device includes a breakage detection tool, a detected member, a sensor unit, and a controller. The breakage detection tool is at least partially located in a through hole arranged in the window glass when the window glass is unbroken and capable of shattering the window glass at a portion surrounding the through hole when the window glass breaks. The detected member is held by the breakage detection tool when the window glass is unbroken and released from the breakage detection tool when the window glass breaks and displaces the breakage detection tool as the window glass shatters. The sensor unit detects displacement of the detected member released from the breakage detection tool and outputs a detection signal in correspondence with the displacement. The controller determines breakage of the window glass based on the detection signal.

### BRIEF DESCRIPTION OF THE DRAWINGS

FIG. 1 is an exploded perspective view showing a right front door of a vehicle to which a breakage detection tool according to one embodiment of the present invention is applied;

FIG. 2 is a schematic front view showing the right front door of FIG. 1;

FIG. 3 is a cross-sectional view taken along line 3-3 in FIG. 2;

FIG. 4 is a perspective view showing the breakage detection tool that is applied to the right front door of FIG. 1;

FIG. 5(a) is a front view showing the detector of FIG. 4, FIG. 5(b) is a plan view, FIG. 5(c) is a side view, and FIG. 5(d) is a cross-sectional view taken along line 5d-5d in FIG. 5(a);

FIG. 6(a) is a cross-sectional view of the detector taken along line 6a-6a in FIG. 5(a), FIG. 6(b) is a cross-sectional view of the detector taken along line 6b-6b in FIG. 5(b), and FIG. 6(c) is an explanatory diagram of an urging force F1 in a cross-section of the detector taken along line 6b-6b in FIG. 5(a);

FIG. 7(a) is a front view showing the detector of FIG. 4, FIG. 7(b) is a plan view, FIG. 7(c) is a side view, and FIG. 7(d) is a cross-sectional view taken along line 7d-7d in FIG. 7(a);

FIG. 8(a) is a front view showing the detector of FIG. 4, FIG. 8(b) is a plan view, FIG. 8(c) is a side view, and FIG. 8(d) is a cross-sectional view taken along line 8d-8d in FIG. 8(a);

FIG. 9(a) is a cross-sectional view taken along line 9a-9a in FIG. 8(a), and FIG. 9(b) is a cross-sectional view taken along line 9b-9b in FIG. 8(a);

FIG. 10 is an output characteristics diagram of the magnetic sensors shown in FIG. 3;

FIG. 11 is a characteristics diagram of the sum of the outputs of the two magnetic sensors shown in FIG. 3; and

FIG. 12 is a front view showing a prior art detection device.

### DETAILED DESCRIPTION OF THE PREFERRED EMBODIMENTS

One embodiment of the present invention will now be discussed with reference to the drawings.

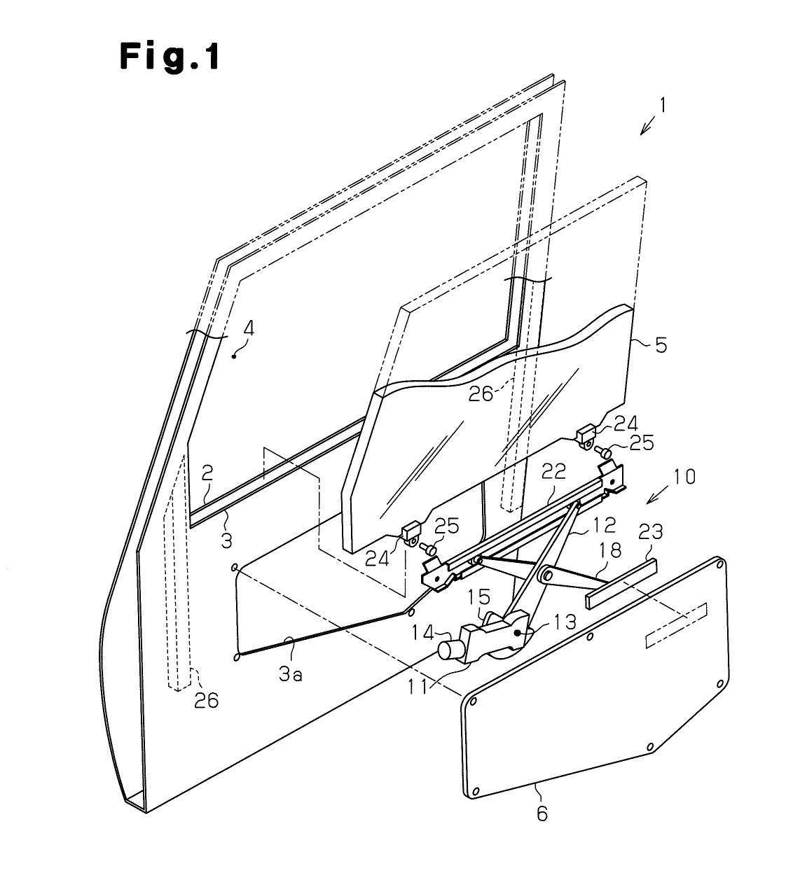

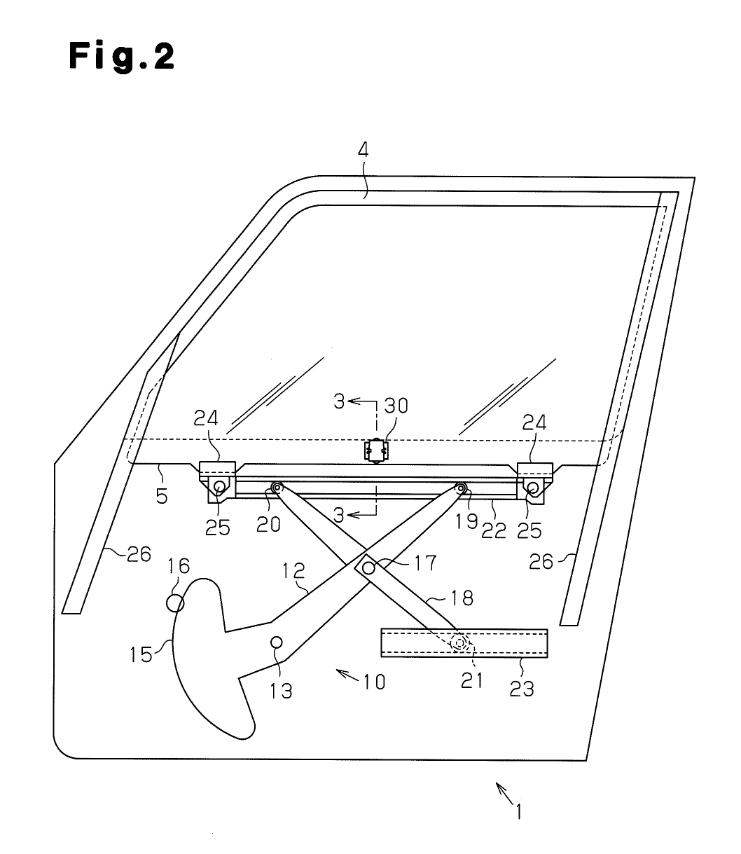

FIG. 1 is an exploded perspective view showing a right front door of a vehicle, and FIG. 2 is a schematic front view showing the right front door of FIG. 1.

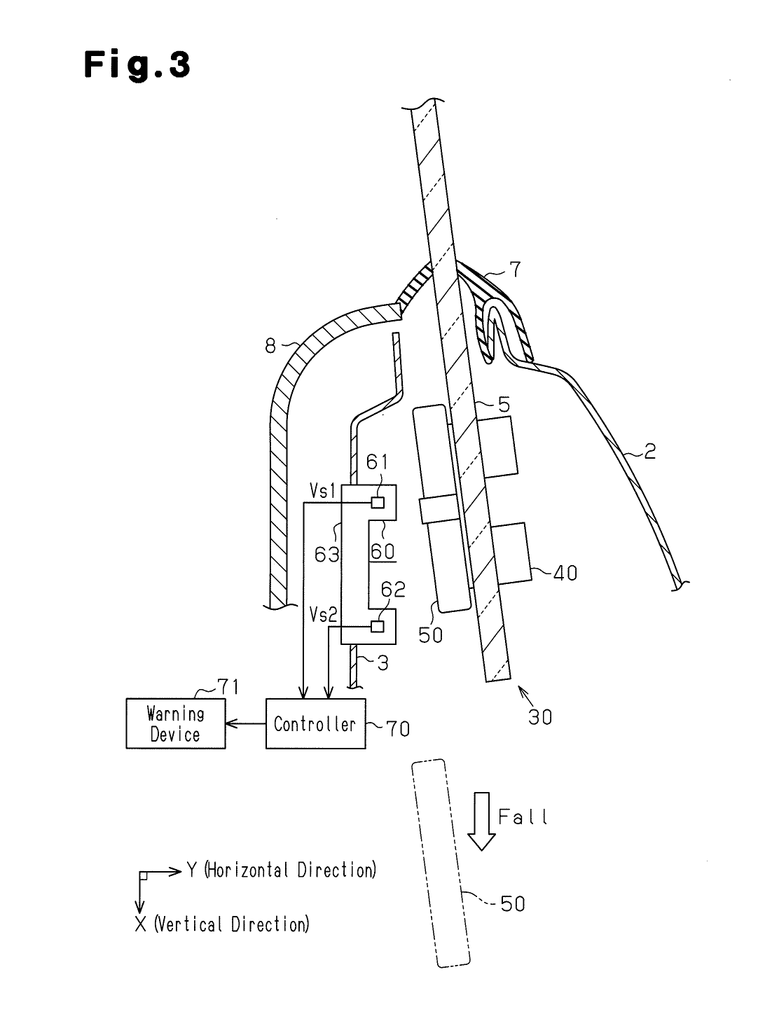

As shown in FIG. 1, a vehicle door 1 includes an outer panel 2 and an inner panel 3. A window glass 5, which is reinforced glass, is arranged between the outer panel 2 and the inner panel 3. The window glass 5 has a thickness of about 3.1 mm to 5.0 mm. A door rim 8 is attached to a vehicle interior side of the inner panel 3 (refer to FIG. 3).

A window regulator 10 that vertically moves the window glass 5 is accommodated in the vehicle door 1. In the present embodiment, an X-arm window regulator is used as the window regulator 10. A door component retaining cavity 3a is formed in the inner panel 3, and a modular panel 6 closes the door component retaining cavity 3a.

The X-arm window regulator 10 is supported by a base plate (fixed base) 11 on a vehicle exterior side surface of the modular panel 6. More specifically, the X-arm window regulator 10 includes a lift arm 12 having a pin 13, which is supported by the base plate 11. The base plate 11 is fixed to the vehicle exterior side surface of the modular panel 6. An electric drive unit 14 serving as a driver is fixed to the base plate 11. As shown in FIG. 2, the lift arm 12 includes a sector gear (driven gear) 15, which is formed integrally with the lift arm 12. The sector gear 15 rotates about the pin 13. The electric drive unit 14 of FIG. 1 includes a pinion 16 (see FIG. 2), which mates with the sector gear 15, and a motor (not shown), which drives the pinion 16.

The lift arm 12 includes an intermediate portion in the longitudinal direction as viewed in FIG. 2. An equalizer arm 18 is pivotally coupled to the intermediate portion of the lift arm 12 by a pin 17. Guide pieces (rollers) 19 and 20 are rotatably coupled to an upper end (distal end) of the lift arm 12 and an upper end (distal end) of the equalizer arm 18, respectively. A guide piece (roller) 21 is rotatably coupled to a lower end of the equalizer arm 18.

The guide piece 19 of the lift arm 12 and the guide piece 20 of the equalizer arm 18 are movably fitted to a window glass bracket 22. The guide piece 21 of the equalizer arm 18 is movably guided by an equalizer arm bracket (orientation maintaining rail) 23, which is fixed to the vehicle exterior side surface of the modular panel 6 of FIG. 1.

Two window glass holders 24 are fixed to the lower edge of the window glass 5. The window glass holders 24 are fixed in advance to the lower edge of the window glass 5. The window glass 5 together with the window glass holders 24 is inserted into a gap formed between the outer panel 2 and the inner panel 3 and then fixed to the window glass bracket 22 by bolts 25.

As shown in FIG. 2, the vehicle door 1 includes a pair of front and rear glass runs 26. The glass runs 26 are formed from a rubber material. The window glass 5 is movably supported by the two glass runs 26, which serve as rail members. In other words, the front and rear ends of the window glass 5 may be moved up and down as guided by the glass runs 26.

When the electric drive unit 14 of FIG. 1 drives the pinion 16, the sector gear 15 pivots the lift arm 12 about the pin 13. As a result, the window glass bracket 22 (window glass 5) is lifted or lowered while remaining generally horizontal due to the equalizer arm 18, the guide pieces 19, 20, and 21, and the equalizer arm bracket 23. In this manner, the window glass 5 is lifted and lowered so that the window glass 5 freely opens and closes an opening 4 of the vehicle.

As shown in FIG. 3, a breakage detection device 30 for preventing unauthorized entry is arranged in the vehicle door 1. The breakage detection device 30 includes a detection tool 40 and a sensor unit 60.

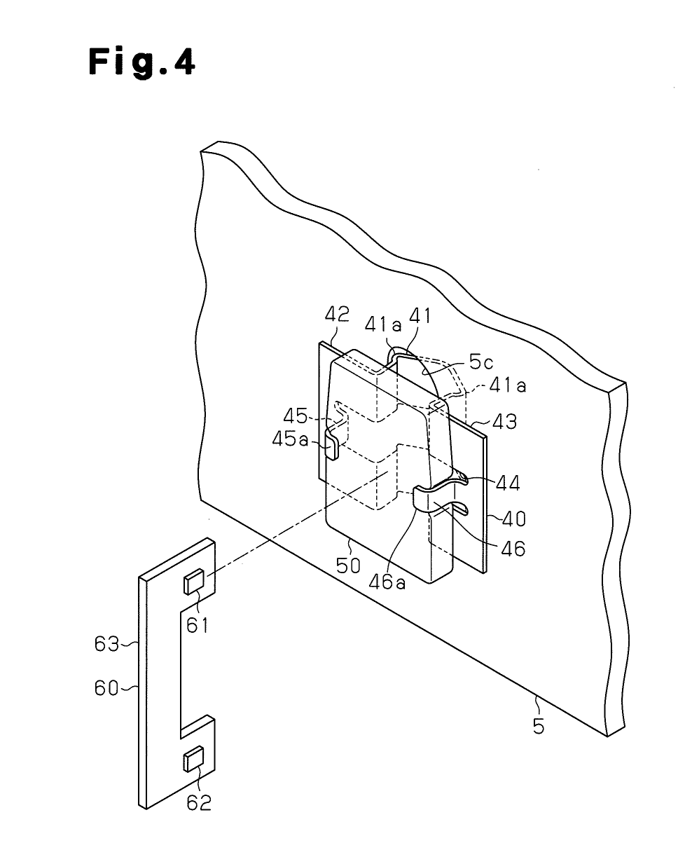

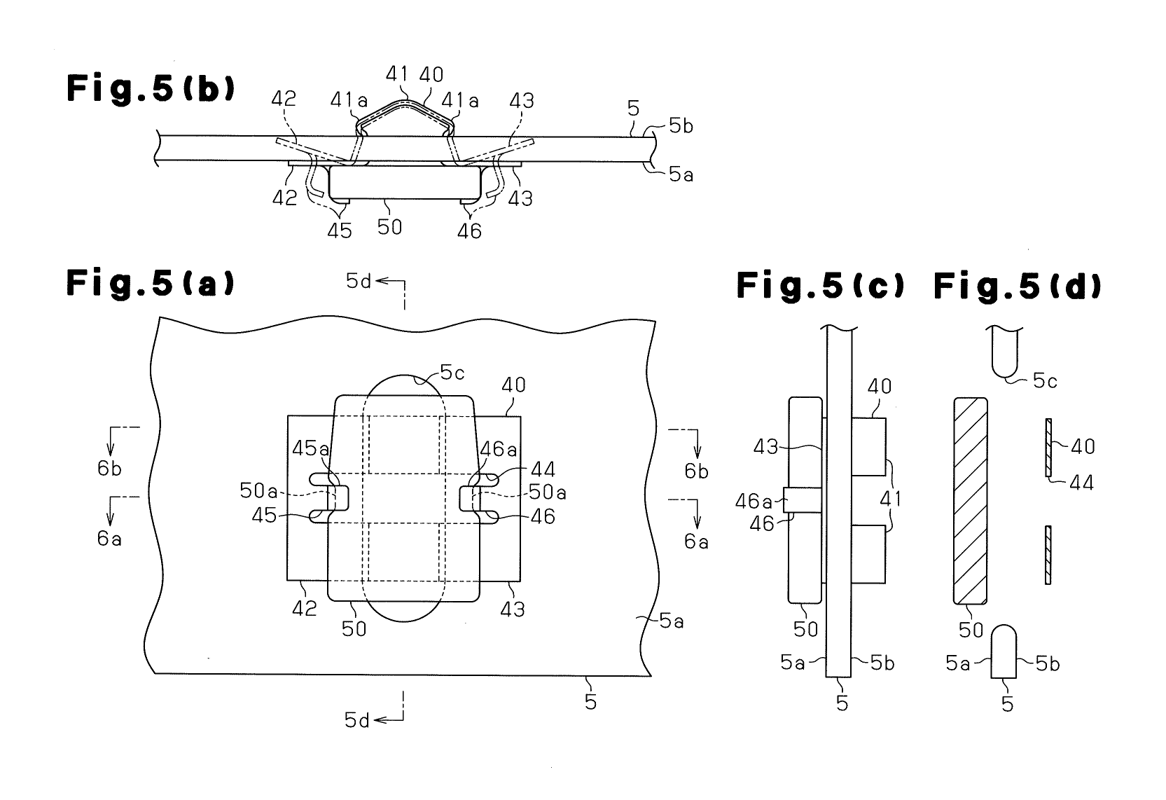

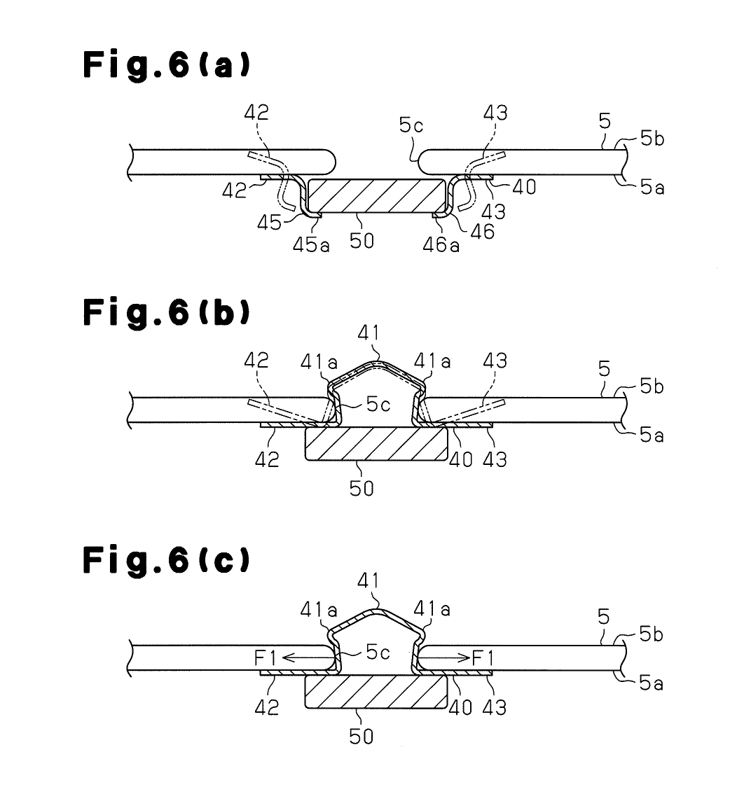

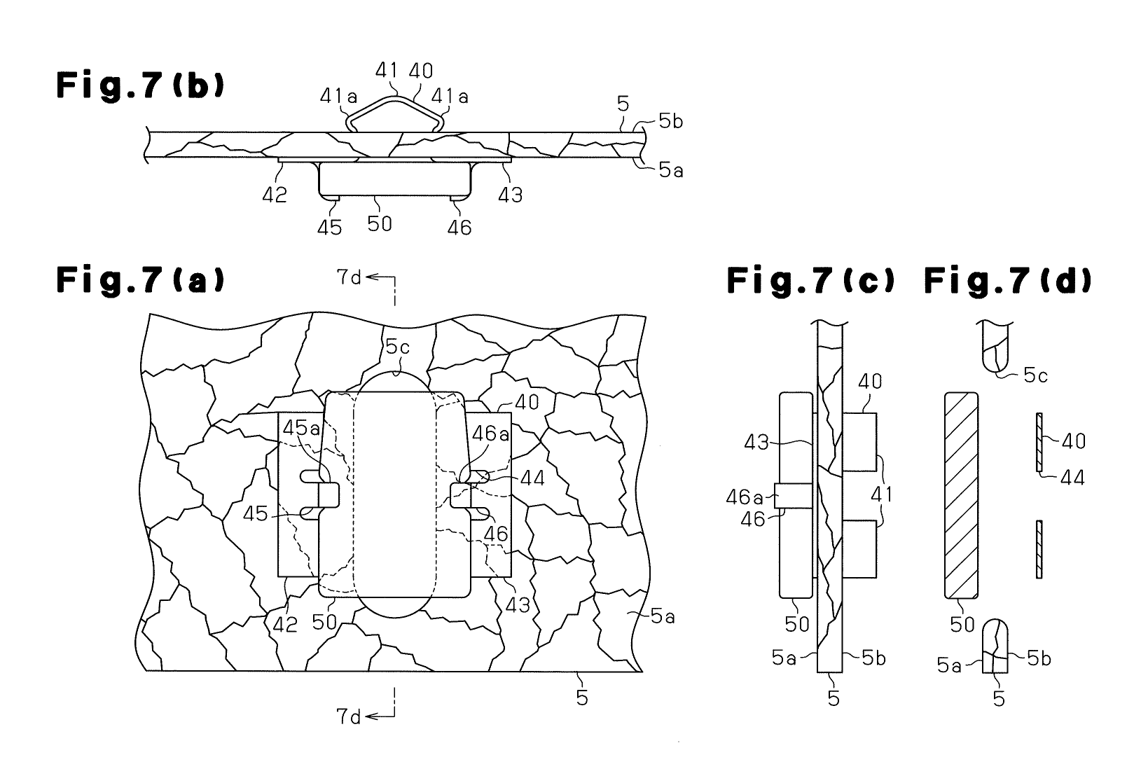

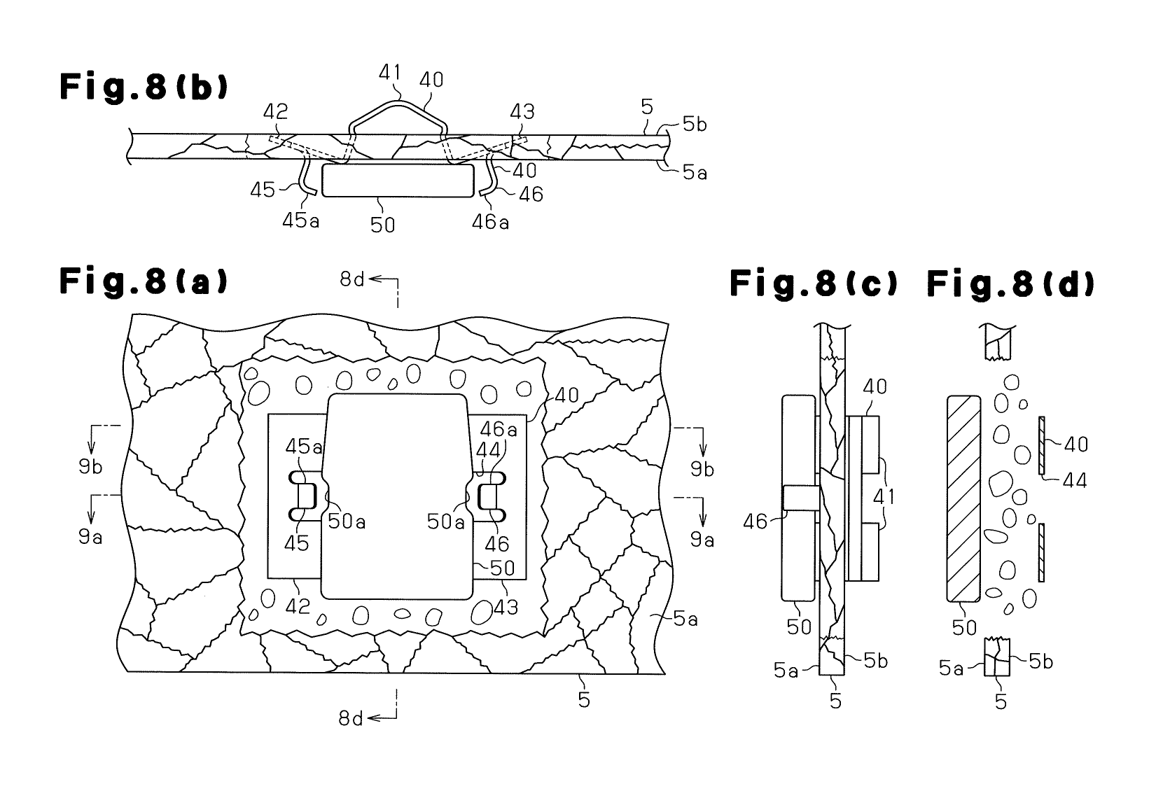

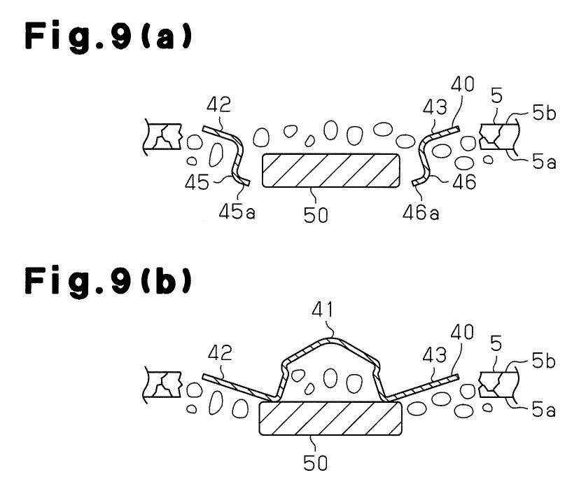

FIG. 4 is a perspective view showing the breakage detection device 30. FIGS. 5 and 6 show a state in which the detection tool 40 is attached to the window glass 5. FIG. 7 shows a state after the detection tool 40 is attached to the window glass 5 in which the window glass 5 is broken and entirely cracked. FIGS. 8 and 9 each show a state in which the window glass 5 is broken and partially shattered by the detection tool 40.

As shown in FIG. 3, the window glass 5 is arranged between the outer panel 2 and the inner panel 3 in a state sealed by a weather strip 7. The door rim 8 is arranged at the vehicle interior side of the inner panel 3. The detection tool 40 is attached to the lower portion of the window glass 5.

As shown in FIGS. 4 and 5(a), a through hole 5c extends through the window glass 5. The through hole 5c is an elongated hole extending in the vertical direction. The detection tool 40 is fixed to the window glass 5 in a state extending through the through hole 5c. The detection tool 40 includes plates 42 and 43, which contacts a front surface 5a of the window glass 5 and holds a magnet 50 on the front surface 5a of the window glass 5. Further, the detection tool 40 has an elastic force such that it is urged in a direction that expands (enlarges) the through hole 5c of the window glass 5.

As shown in FIG. 6, the detection tool 40 is formed to hold the permanent magnet 50, which serves as a detected member, when the window glass 5 is unbroken and release the magnet 50 when the window glass 5 is broken. The permanent magnet 50 has the shape of a tetragonal plate and includes cutouts (recesses) 50a in the left and right surfaces (refer to FIG. 8a)).

As shown in FIGS. 5 and 6, the detection tool 40 is formed by bending a strip of a plate spring steel sheet, which extends laterally. The detection tool 40 includes a fastener 41 and the plates 42 and 43. The fastener 41, which is formed to have a generally U-shaped cross-section, is deformed and inserted into the through hole 5c of the window glass 5. This arranges the fastener 41 in a state extending through the through hole 5c of the window glass 5.

The plates 42 and 43 are shaped as tetragonal plates and extend from both ends of the fastener 41. As shown in FIG. 6(c), at the side of a rear surface 5b of the window glass 5, the fastener 41 has an engagement portion 41a that is wider than the through hole 5c of the window glass 5. This prevents the detection tool 40 from falling out of the through hole 5c. Further, referring to FIGS. 5(b), 6(a), and 6(b), the detection tool 40 deforms against its spring force from the shape shown by the double-dashed lines to the shape shown by the solid lines. The fastener 41 urges (presses) the wall of the through hole 5c in a direction expanding the through hole 5c of the window glass 5.

In detail, as shown in FIG. 6(c), the two sides of the fastener 41 presses the wall surface defining the through hole 5c in a direction expanding the through hole 5c. That is, the plates 42 and 43 have the form shown by the double-dashed lines in FIG. 6(b) before attachment of the detection tool 40 to the window glass 5 and have the form shown by the solid lines in FIG. 6(b) when the detection tool 40 is attached to the window glass 5. More specifically, when attached to the window glass 5, the detection tool 40 is deformed in contact with the front surface 5a of the window glass 5 so that the fastener 41 urges the wall of the through hole 5c in an expanding direction. That is, as shown in FIG. 6(b), the detection tool 40, which is formed from a spring material, is in a state expanded toward the left and right before attachment to the through hole 5c of the window glass 5. However, as shown in FIG. 6(c), when the detection tool 40, which is formed from a spring material, is attached to the through hole 5c, the fastener 41 in the through hole 5c presses and applies outward urging forces F1, which act in opposite directions, to the wall defining the through hole 5c.

In this manner, the arrangement of the through hole 5c at any location on the window glass 5 allows for the detection tool 40 to be attached to the window glass 5 at that location (for example, a position that is not located at an end portion of the window glass 5). The detection tool 40 is arranged in the vehicle door 1 at an unnoticeable location.

As shown in FIG. 5, the detection tool 40 includes two arms 45 and 46, which serve as a holder for holding the permanent magnet 50. The two arms 45 and 46 cooperate with the plates 42 and 43 to hold the permanent magnet 50 when the window glass 5 is unbroken and release the permanent magnet 50 when the window glass 5 is broken.

In detail, the detection tool 40 has a central portion with respect to the lateral direction in which a slot 44 is formed. The two arms 45 and 46 extend toward the central portion from the left and right walls defining the slot 44 in the detection tool 40. The arms 45 and 46 have the shape of linearly extending strips and are bent twice in a cranked manner as shown in FIGS. 4 and 6(a). In a state in which the detection tool 40 is attached to the window glass 5, distal ends of the arms 45 and 46 are engaged with the edges of the permanent magnet 50 (edges at the cutouts 50a). This restricts movement of the permanent magnet 50 in the lateral direction and vertical direction. That is, as shown by the double-dashed lines in FIG. 6(a), the arms 45 and 46 are located at positions spaced apart from the magnet 50 before the detection tool 40 is attached to the window glass 5. When the detection tool 40 is attached to the window glass 5, the arms 45 and 46 are deformed as shown by the solid lines in FIG. 6(a) to hold the two sides of the magnet 50 from the front with its magnet engagement portions 45a and 46a.

As shown in FIG. 3, the sensor unit 60 is fixed to the inner panel 3. Here, the vertical direction is defined as the X-direction, and the horizontal direction is defined as the Y-direction. The permanent magnet 50 is movable in the X-direction, that is, allowed to fall down.

The sensor unit 60 includes a first magnetic sensor (magnetic sensor element) 61, a second magnetic sensor (magnetic sensor element) 62, and a substrate 63. The first magnetic sensor 61 and the second magnetic sensor 62 are arranged on the substrate 63 and spaced apart in the vertical direction. Specifically, the magnetic sensors 61 and 62 are spaced apart by about 4 cm. When the window glass 5 is fully closed, the first magnetic sensor 61 is arranged at the same height as the magnet 50 and spaced apart from the magnet 50 by a predetermined distance in the Y-direction. The second magnetic sensor 62 is located below the first magnetic sensor 61. Accordingly, the permanent magnet 50 passes by the front of the second magnetic sensor 62 when the magnet 50 falls.

The magnetic sensors 61 and 62 output signals corresponding to the distance from the magnet 50. In the state of FIG. 3, the first magnetic sensor 61 is arranged at the same height as the magnet 50 and thus has a high output voltage. Further, the second magnetic sensor 62 is arranged below the first magnetic sensor 61 and thus has a low output voltage. Hall ICs may be used as the magnetic sensors 61 and 62.

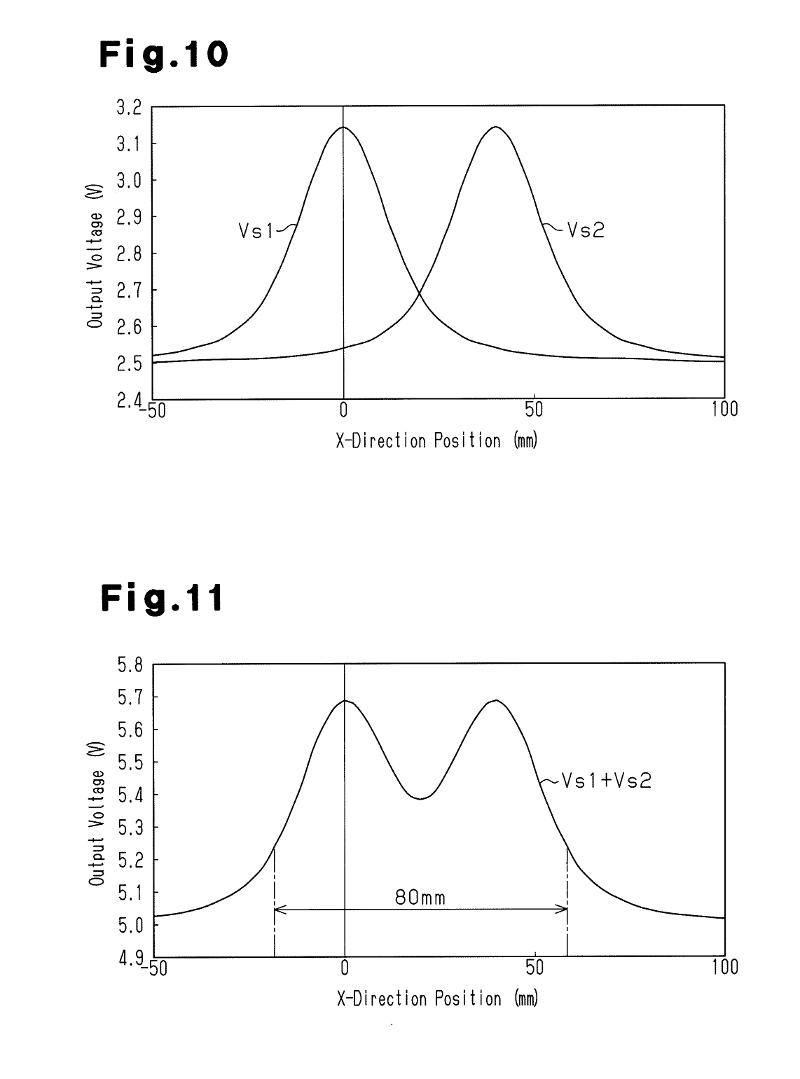

As shown in FIG. 3, the magnetic sensors 61 and 62 are connected to a controller 70. The controller 70 includes an A/D converter and a microcomputer. The A/D converter converts analog data output from the magnetic sensors 61 and 62 into signals of digital data (output voltages Vs1 and Vs2), which is retrieved by the microcomputer. The microcomputer adds the output voltages (digital values) of the magnetic sensors 61 and 62 to obtain a sum Vn (=Vs1+Vs2) of the output signals shown in FIG. 11. This obtains a signal having a high output level in a wider range (80 mm in FIG. 11) compared to when solely using the output voltage Vs1 or Vs2 of each of the magnetic sensors 61 and 62 shown in FIG. 10. As a result, the location of the magnet 50 may be detected over a wide range. As shown in FIG. 3, a warning device 71 is connected to the controller 70.

The operation of the detection tool 40 when the window glass 5 is broken will now be discussed.

FIGS. 4, 5, and 6 show the detection tool 40 in a normal state, or when the window glass 5 is unbroken. The window glass 5 may be fully closed or slightly open (for a few centimeters) when the vehicle occupant leaves the vehicle. In this case, the controller 70 detects the position of the window glass 5 from the sensor output level of FIG. 11. When the parking brake is operated and the window glass 5 is fully closed or slightly open, the controller 70 sets a glass breakage detection mode. In this state, the detection tool 40 attached to the lower portion of the window glass 5 urges the through hole 5c in an expanding direction. Further, when the window glass 5 is unbroken, the two arms 45 and 46 cooperate with the plates 42 and 43 to hold the magnet 50. In the unbroken state, the magnet 50 is located in front of the first magnetic sensor 61 of the sensor unit 60.

In this state, breakage of the window glass 5 lowers the strength of the window glass. That is, partial breakage of the window glass 5, which is reinforced glass, forms cracks throughout the entire window glass 5 as shown in FIG. 7 and drastically decreases the strength.

As the strength decreases, the detection tool 40 shatters with its urging force the portion of the window glass 5 surrounding the through hole 5c (part of the window glass 5), as shown in FIGS. 8 and 9. In other words, the detection tool 40 completely shatters part of the window glass 5, which is formed from reinforced glass, with its spring force. As shown in FIG. 9(b), this displaces the plates 42 and 43 toward the rear surface 5b of the window glass 5. The displacement of the plates 42 and 43 pivots the arms 45 and 46. As shown in FIG. 9(a), this moves the magnet engagement portions 45a and 46a and releases the engagement (holding) of the permanent magnet 50. As a result, the permanent magnet 50 falls.

In the sensor unit 60, prior to the breakage of the window glass 5, the sum Vn (=Vs1+Vs2) of the output signals of the magnetic sensors 61 and 62 has a value that is greater than or equal to a predetermined threshold value. However, when the window glass 5 breaks and the magnet 50 falls, the sum of the output voltages of the magnetic sensors 61 and 62 is no longer greater than or equal to the predetermined threshold value. Thus, the falling of the permanent magnet 50 is detected. As a result, breakage of the window glass 5 is detected.

As described above, reinforced glass has a feature in which partial breakage of the glass forms cracks entirely in the glass and thereby drastically decreases the strength. This feature is used to minimize detection failure and erroneous detection of the breakage of the window glass 5.

In other words, even when the window glass 5 breaks but holds together without being completely shattered, breakage detection of the window glass 5 is ensured. Further, the detection tool 40 urges the through hole 5c in the expanding direction. This ensures shattering of part of the window glass 5 when the window glass 5 breaks (as the strength of the window glass 5 decreases).

Further, when the window glass 5 is not located at the fully-closed position as shown in FIG. 2, the magnet 50 also falls when the window glass 5 breaks. This allows the breakage detection device 30 to detect breakage of the window glass 5. In detail, in the prior art detection device (patent document 1), movement of the window glass is detected when the window glass is fully closed. Thus, when the window glass is not located at the fully-closed position, breakage of the window glass could not be detected. In contrast, the breakage detection device 30 of the present embodiment allows for breakage detection of the window glass 5 when the window glass 5 is slightly open for ventilation or the like.

Moreover, when the window glass 5 breaks, the magnet 50 is released and the falling of the magnet 50 is detected. Thus, breakage of the window glass 5 is detected, for example, even when the detection tool 40 gets caught somewhere in the vehicle body or the falling of the detection tool 40 is interfered with due to the detection tool 40 remaining on the window glass 5.

When breakage of the window glass 5 is detected as the sensor unit 60 detects falling of the permanent magnet 50 from the output voltages of the magnetic sensors 61 and 62, the controller 70 activates the warning device 71 as shown in FIG. 3 and issues a warning.

The embodiment discussed above has the advantages described below.

(1) The detection tool 40 is located in the through hole 5c, which is arranged in the window glass 5, to urge the through hole 5c of the window glass 5 with its elastic force in an expanding direction. Accordingly, when the window glass 5 breaks, the detection tool 40 shatters the portion of the window glass 5 surrounding the through hole 5c and is at least partially displaced. This ensures that the breakage detection device 30 detects breakage of the window glass 5 even when the window glass 5 holds together without being completely shattered.

Further, in the prior art (patent document 1), the regulator must be modified. This may lower the reliability and quality. However, the structure of the present embodiment does not require the regulator to be modified and thus has superior reliability and quality. Moreover, the structure of the prior art is complicated. This may increase costs. However, the present embodiment has a simple structure. This allows for the breakage detection device 30 to be relatively inexpensive.

(2) The detection tool 40 is attached to the window glass 5, which freely opens and closes an opening of a vehicle. Further, the detection tool 40 detects breakage of the window glass 5 even when the window glass 5 is not located at the fully-closed position.

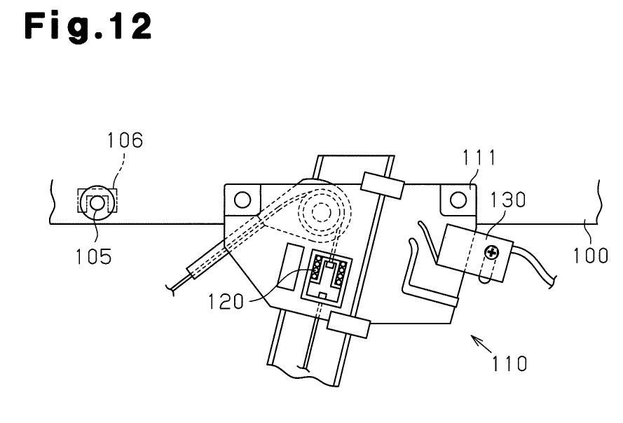

In detail, in the prior art detection device shown in FIG. 12, the structure detects only displacement of the window glass 100 in the closing direction from the fully-closed position. Thus, when the window glass 100 is not located at the fully-closed position, that is, when the window glass 100 is slightly open for ventilation, the detection device cannot detect breakage of the window glass 100. In contrast, in the present embodiment, breakage of the window glass 5 is detected even when the window glass 5 is not located at the fully-closed position.

(3) The detection tool 40 is formed by bending a strip of a plate spring steel sheet. Thus, the detection tool 40 urges the through hole 5c of the window glass 5 in the expanding direction with a simple structure.

(4) Displacement of part of the detection tool 40 releases the magnet 50, which serves as a detected member. Thus, breakage of the window glass 5 is detected from movement of the magnet 50 and not from the movement of the detection tool 40.

(5) The magnet 50 is held by the two arms 45 and 46. Thus, the magnet 50 is held with a simple structure.

Embodiments are not limited to the foregoing description and may be embodied as described below.

An X-arm window regulator is used for the window regulator. Instead, a cable window regulator may be used.

The driver is not limited to a motor and may be manually driven by a vehicle occupant.

The breakage detection device 30 is applied to the right front door of a vehicle. However, the window glass breakage detection device may be applied to other side doors, a rear door or an openable glass roof, which is arranged in a roof.

The sensor unit 60 includes the two magnetic sensors 61 and 62 but may include just one magnetic sensor.

A magnetic sensor is used as the sensor unit 60. However, an infrared sensor may be used as the sensor, and the detection tool 40 may include an infrared reflective member (mirror) facing toward the infrared sensor. More specifically, an infrared reflective mirror may be used in lieu of the magnet 50 of FIG. 5, and an infrared sensor may be used in lieu of the magnetic sensor unit 60. The infrared sensor emits infrared rays and receives reflection light from the reflective mirror to detect when the mirror falls based on the existence of the reflection light. That is, the breakage detection device 30 does not have to be of a magnetic detection type and may be of a light reflection detection type.

Instead of a plate spring steel sheet, the detection tool 40 may be formed from other elastic materials, such as a carbon fiber material.

Instead of an openable window glass, the breakage detection device 30 may be attached to a fixed type (fitting type) window glass.

In FIG. 6 and the other drawings, the detection tool 40 is arranged so as to extend between the front surface 5a and rear surface 5b of the window glass 5 but is not limited in such a manner. As long as at least part of the detection tool 40 is located in the through hole 5c of the window glass, the through hole 5c may be urged in the expanding direction, and breakage of the window glass may be detected by displacing at least part of the detector when the window glass is shattered.

1. A window glass breakage detection tool attached to a window glass for a vehicle and used to detect breakage of the window glass, wherein:
when the window glass is unbroken, at least part of the breakage detection tool is located in a through hole arranged in the window glass and urges a wall of the through hole in a direction expanding the through hole with an elastic force of the detection tool; and
when the window glass breaks, the breakage detection tool shatters the window glass at a portion surrounding the through hole and the detector is at least partially displaced.

2. The breakage detection tool according to claim 1, wherein the breakage detection tool is attached to the window glass that freely opens and closes an opening of the vehicle.

3. The breakage detection tool according to claim 1, wherein the breakage detection tool is formed by bending a strip of a plate spring steel sheet.

4. The breakage detection tool according to claim 1, wherein the breakage detection tool is formed to release a held detected member when partially displaced.

5. The breakage detection tool according to claim 4, comprising:
two arms that hold the detected member.

6. The breakage detection tool according to claim 5, wherein the breakage detection tool is displaced so that the two arms move away from each other when the window glass breaks.

7. The breakage detection tool according to claim 5, comprising:
a fastener inserted into the through hole and having a substantially U-shaped cross-section; and
two plates extending in opposite directions from both ends of the fastener;
wherein the two arms respectively extend from the plates.

8. The breakage detection tool according to claim 7, wherein the fastener includes two engaging portions engaged with the window glass, and the plates are located at a side of the window glass that is opposite to the engaging portions when the fastener is inserted into the through hole.

9. A breakage detection device that detects breakage of a window glass of a vehicle, the breakage detection device comprising:
a breakage detection tool that is at least partially located in a through hole arranged in the window glass when the window glass is unbroken and capable of shattering the window glass at a portion surrounding the through hole when the window glass breaks;
a detected member held by the breakage detection tool when the window glass is unbroken and released from the breakage detection tool when the window glass breaks and displaces the breakage detection tool as the window glass shatters; and
a sensor unit that detects displacement of the detected member released from the breakage detection tool and outputs a detection signal in correspondence with the displacement; and
a controller that determines breakage of the window glass based on the detection signal.

10. The breakage detection device according to claim 9, wherein the detected member has the shape of a tetragonal plate and has cutouts in its two side surfaces, and the breakage detection tool holds the detected member in a state in which the breakage detection tool is engaged with the cutouts.
